(19) United States
(12) Patent Application Publication
(10) Pub. No.: US 2024/0174123 A1
(43) Pub. Date: May 30, 2024

(54) CONTROL DEVICE FOR VEHICLE

(71) Applicant: TOYOTA JIDOSHA KABUSHIKI KAISHA, Toyota-shi Aichi-ken (JP)

(72) Inventors: Shingo ETO, Gamagori-shi Aichi-ken (JP); Noritaka TAKUDA, Okazaki-shi Aichi-ken (JP)

(73) Assignee: TOYOTA JIDOSHA KABUSHIKI KAISHA, Toyota-shi Aichi-ken (JP)

(21) Appl. No.: 18/374,015

(22) Filed: Sep. 28, 2023

(30) Foreign Application Priority Data
Nov. 28, 2022 (JP) 2022-189422

(51) Int. Cl. B60L 58/12

(52) U.S. Cl. CPC B60L 58/12; B60L 2240/547

(57) ABSTRACT

A control device for a vehicle is configured to control a vehicle including an electric motor driven by electric power from a battery and an air conditioning device operated by the electric power from the battery. The control device includes a processor. The processor is configured, when the vehicle is not traveling, to execute a calculation process of calculating a predicted electricity consumption rate of the vehicle in future travel. In the calculation process, the processor is configured to correct a basic value of the predicted electricity consumption rate based on past air conditioning operation information of at least one of the vehicle and one or more other vehicles.

### CROSS-REFERENCES TO RELATED APPLICATION

The present disclosure claims priority under 35 U.S.C. § 119 to Japanese Patent Application No. 2022-189422, filed on Nov. 28, 2022, which is incorporated herein by reference in its entirety.

### TECHNICAL FIELD

The present disclosure relates to a control device for a vehicle.

### BACKGROUND

JP 2018-064329 A discloses a technique for calculating a travelable distance based on electricity consumption rate and remaining battery level of a vehicle. More specifically, this electricity consumption rate is actual electricity consumption rate, and is calculated in consideration of actual electric power actually consumed by the vehicle during traveling and power consumption of electrical components.

### SUMMARY

The technique disclosed in JP 2018-064329 A, cannot predict the electricity consumption rate in future travel while considering the use of an air conditioning device when the vehicle is not traveling, such as during charging. As just described, there is room for improvement in the application of the above-described technique to the calculation of the predicted electricity consumption rate executed when the vehicle is not traveling.

The present disclosure has been made in view of the problem described above, and an object of the present disclosure is to provide a control device for a vehicle that can appropriately calculate, during a period other than a travel period of the vehicle, a predicted electricity consumption rate in the future travel while taking into consideration the use of an air conditioning device.

A control device for a vehicle according to the present disclosure is configured to control a vehicle including an electric motor driven by electric power from a battery and an air conditioning device operated by the electric power from the battery. The control device includes a processor. The processor is configured, when the vehicle is not traveling, to execute a calculation process of calculating a predicted electricity consumption rate of the vehicle in future travel. In the calculation process, the processor is configured to correct a basic value of the predicted electricity consumption rate based on past air conditioning operation information of at least one of the vehicle and one or more other vehicles.

According to the present disclosure, when the vehicle is not traveling, the predicted electricity consumption rate in the future travel can be calculated appropriately in consideration of the use of the air conditioning device.

### BRIEF DESCRIPTION OF DRAWINGS

FIG. 1 is a diagram schematically showing a configuration of a vehicle according to an embodiment; and

FIG. 2 is a flowchart showing an example of processing related to calculation of a predicted electricity consumption rate Ep and display of a travelable distance L based on the predicted electricity consumption rate Ep according to the embodiment.

### DETAILED DESCRIPTION

### 1. Configuration Example of Vehicle

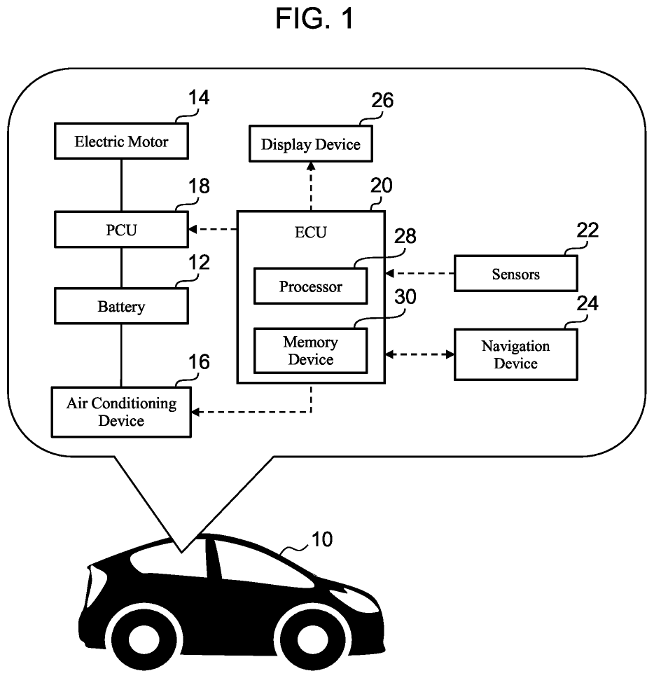

FIG. 1 is a diagram schematically showing a configuration of a vehicle 10 according to an embodiment. The vehicle 10 is a battery electric vehicle (BEV) and includes a battery 12 and an electric motor 14. The vehicle 10 can perform electric traveling (i.e., EV traveling) using the electric motor 14 driven by electric power from the battery 12. The “vehicle” according to the present disclosure may be, for example, a plug-in hybrid electric vehicle (PHEV) as long as the “vehicle” can perform the electric traveling.

The vehicle 10 further includes an air conditioning device 16, a power control unit (PCU) 18, an electronic control unit (ECU) 20, sensors 22, a navigation device 24, and a display device 26.

The air conditioning device 16 is operated by electric power from the battery 12, and performs air conditioning of the interior of the vehicle 10, more specifically, at least one of cooling and heating. The PCU 18 is a power converter including an inverter for driving the electric motor 14. The PCU 18 controls the electric motor 14 using the electric power of the battery 12 based on a command from the ECU 20.

The ECU 20 is a computer that controls the vehicle 10 and corresponds to an example of the “control device for a vehicle” according to the present disclosure. The ECU 20 includes a processor 28 and a memory device 30. The processor 28 executes various processes. The various processes include processes related to control of the electric motor 14 and the air conditioning device 16, and processes related to display of a predicted electricity consumption rate Ep and a travelable distance L based on the predicted electricity consumption rate Ep. The predicted electricity consumption rate Ep will be described below. The memory device 30 stores various types of information necessary for processing by the processor 28. The processor 28 executes one or more computer programs, whereby various processes by the ECU 20 are realized. The one or more computer programs are stored in the memory device 30. Alternatively, the one or more computer programs may be recorded on a computer-readable recording medium. The ECU 20 is operated by, for example, electric power from an auxiliary battery (not shown). In addition, the ECU 20 may be configured by combining a plurality of ECUs.

The sensors 22 include, for example, an outside air temperature sensor, a vehicle interior temperature sensor, a battery current sensor, and an electric power sensor. The battery current sensor detects a charge/discharge current of the battery 12. The ECU 20 calculates a charging rate (SOC: State Of Charge) of the battery 12 based on the detected charge/discharge current. The power sensor detects a consumed power (air conditioning power consumption) Pac of the air conditioning device 16. In addition, the navigation device 24 is configured to be able to communicate with an external system via a wireless communication network, and can acquire various kinds of information from the external system.

The various kinds of information described above include vehicle environment information 12 related to use of air conditioning. To be specific, the vehicle environment information 12 is information related to various parameters indicating the environment surrounding the vehicle 10 such as the state of the vehicle 10, the traveling environment, and the traveling condition. The various parameters are acquired using, for example, the sensors 22 and the navigation device 24, and include, for example, the outside air temperature, the day of the week, time, and the vehicle interior temperature. In addition, the various parameters correspond to explanatory variables related to the air conditioning operation by a person on the vehicle 10.

The display device 26 is, for example, a display such as a meter panel mounted on an instrument panel of the vehicle 10. The display device 26 displays, for example, the travelable distance L. In addition, the “display device” according to the present disclosure may not necessarily be mounted on a vehicle, and may be, for example, a communication terminal operated by a person on the vehicle.

### 2. Calculation of Predicted Electricity Consumption Rate and Display of Travelable Distance Based Thereon

In the present embodiment, the ECU 20 (processor 28) executes a “calculation process PR1” in order to display the travelable distance L on the display device 26 when the vehicle 10 is not traveling. Here, “when the vehicle is not traveling” is when the system of the vehicle 10 is not activated, and, for example, when the vehicle 10 (battery 12) is being charged as exemplified below. In addition, a state in which the vehicle 10 is not being charged but is stopped corresponds to another example of “when the vehicle is not traveling”. The travelable distance L means a distance that can be traveled by the electric traveling using remaining battery level Wb of the battery 12.

The calculation process PR1 is executed by the ECU 20 operated by the auxiliary battery when the system of the vehicle 10 is not activated. According to the calculation process PR1, the predicted electricity consumption rate Ep of the vehicle 10 in the future travel is calculated. The “electricity consumption rate” is a power consumption rate, and is specified as, for example, an amount of power per unit distance [Wh/km]. The term “future travel” as used herein refers to, for example, a scheduled next travel.

In the calculation process PR1, the ECU 20 corrects a basic value Epb of the predicted electricity consumption rate Ep based on air conditioning operation information I during the past travel of the vehicle 10. More specifically, the “air conditioning operation information I” is, for example, information related to an operation of the air conditioning device 16 by a person on the vehicle 10, such as a driver, in one or more past trips of the vehicle 10.

To be more specific, the air conditioning operation information I includes air conditioning operation result information I1 and the above-described vehicle environment information 12. The ECU 20 executes a “learning process PR2” for learning an air conditioning operation probability X, which is a probability that the air conditioning operation will be performed during the future travel (more specifically, during a future trip), based on the air conditioning operation result information I1 and the vehicle environment information 12. The air conditioning operation probability X is, for example, a numerical value of 0 or more and 1 or less, in other words, a numerical value of 0% or more and 100% or less.

Also, in the calculation process PR1, the ECU 20 calculates an air conditioning electricity consumption rate correction amount Cac, which is a correction amount related to electricity consumption rate Eac of the air conditioning device 16, based on the product of the air conditioning operation probability X learned in the learning process PR2 and the air conditioning power consumption Pac. Then, the ECU 20 corrects the basic value Epb of the predicted electricity consumption rate Ep with the air conditioning electricity consumption rate correction amount Cac.

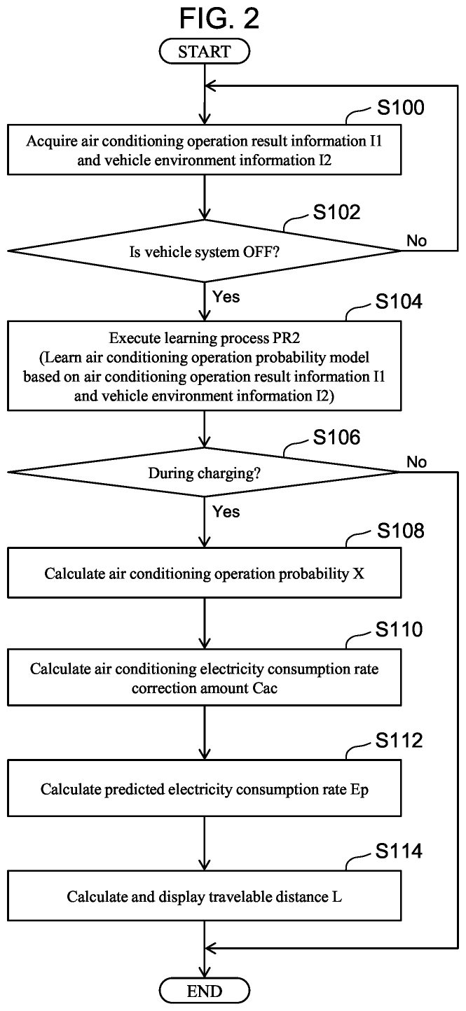

FIG. 2 is a flowchart illustrating an example of processing related to calculation of the predicted electricity consumption rate Ep and display of the travelable distance L based on the predicted electricity consumption rate Ep according to the embodiment. The processing of this flowchart is started when the system of the vehicle 10 is activated, that is, when the power switch (i.e., ignition switch) of the vehicle 10 is turned on by the driver.

In step S100, the ECU 20 (processor 28) acquires the air conditioning operation result information I1 and the vehicle environment information 12.

The air conditioning operation result information (or simply, operation result information) I1 is information on a result of an air conditioning operation performed by a person on the vehicle 10 when the vehicle system is ON, that is, during the current trip of the vehicle 10. For example, the operation result information I1 is a signal (for example, a signal indicating ON/OFF of the air conditioning) from an operating device of the air conditioning device 16 operated by the person. Alternatively, the operation result information I1 may be, for example, the air conditioning power consumption Pac detected by the above-described power sensor or a time integrated value of the air conditioning power consumption Pac. The processing of this step S100 is repeatedly executed while the vehicle system is ON (step S102; No). Therefore, the operation result information I1 is repeatedly acquired during the current trip. As a result, the information on the usage history of the air conditioning during the current trip by the person onboard is acquired as the operation result information I1.

The acquisition of the various parameters such as the outside air temperature, the day of the week, time, and the vehicle interior temperature included in the vehicle environment information 12 may not necessarily be performed repeatedly during the current trip, and may be performed only once during the current trip, for example. In addition, the acquired vehicle environment information 12 may include information for specifying a person onboard, such as a driver of the vehicle 10. The reason for this is that the manner in which the air conditioning is used differs depending on persons onboard. The person onboard can be identified by using, for example, an image captured by an in-vehicle camera.

On the other hand, when the ECU 20 determines in step S102 that the vehicle system is turned OFF (i.e., ignition OFF), the processing proceeds to step S104. In step S104, the ECU 20 executes the learning process PR2 described above. A method of learning the air conditioning operation probability X by the learning process PR2 is not particularly limited, but the learning can be performed using, for example, an air conditioning operation probability model. The air conditioning operation probability model is a machine learning model constructed with the above-described various parameters (i.e., “a plurality of parameters”) included in the vehicle environment information 12 as an input and the air conditioning operation probability X as an output. The learning of the air conditioning operation probability model is performed using the learning date acquired during the most recent trip in step S100, that is, using the above-described various parameters, which are explanatory variables (inputs), and the operation result information I1 which is an objective variable.

According to the processing of step S104 described above, learning of the air conditioning operation probability model proceeds each time the trip of the vehicle 10 ends. As described above, the learning of the air conditioning operation probability model is performed using the operation result information I1 and vehicle environment information 12 of a plurality of past trips.

In step S106 following step S104, the ECU 20 determines whether or not the vehicle 10 is being charged. This determination can be made based on, for example, the charge/discharge current of the battery 12 detected by the battery current sensor described above. As a result, when the vehicle 10 is not being charged (step S106; No), the processing proceeds to END. On the other hand, when the vehicle 10 is being charged (step S106; Yes), the processing proceeds to step S108.

In step S108, the ECU 20 calculates an air conditioning operation probability X at the next scheduled traveling time. To be specific, the ECU 20 calculates an air conditioning operation probability X from the air conditioning operation probability model and predicted values of the various parameters at the next scheduled traveling time. The “predicted values of the parameters” referred to herein are predicted values of, for example, the outside air temperature, the day of the week, time, the vehicle interior temperature at the next scheduled traveling time acquired using, for example, the following method.

Here, the navigation device 24 receives input of information related to the next travel plan from the user of the vehicle 10. The input information includes, for example, the day of the week and a departure time on which the vehicle 10 is scheduled to be used, and a departure point and a destination. The navigation device 24 generates traveling route information from the departure point to the destination based on the input information. The traveling route information includes, for example, a predicted arrival time at the destination, and a distance (trip distance) and a time (trip time) from the departure point to the destination. Then, based on the traveling route information at the next scheduled traveling time, the navigation device 24 acquires, for example, a time zone of the next scheduled traveling, and acquires (estimates) an outside air temperature and a vehicle interior temperature in the time zone from weather forecast information (for example, temperature and solar radiation amount) in the time zone. Then, the ECU 20 acquires predicted values of the various parameters, such as the outside air temperature, from the navigation device 24.

Additionally, the input information from the user may be acquired using, for example, a mobile terminal of the user. In addition, at least a part of the processing related to the calculation of the predicted values based on the input information may be executed by the ECU 20 that acquires the input information from the navigation device 24 or the mobile terminal instead of the navigation device 24 or the mobile terminal.

Then, in step S110, the ECU 20 calculates an air conditioning electricity consumption rate correction amount Cac based on the product of the air conditioning operation probability X calculated in step S108 and the air conditioning power consumption Pac. Specifically, the air conditioning power consumption Pac used in this calculation is, for example, a value calculated in advance, such as rated power consumption of the air conditioning device 16. Alternatively, the air conditioning power consumption Pac may be, for example, a learned value. Similarly to the air conditioning operation probability X, the learned value may be calculated using, for example, an air conditioning power consumption model that is learned based on the various parameters included in the above-described vehicle environment information and the operation result information I1. That is, the learned value may be calculated from the air conditioning power consumption model and the predicted values of the various parameters at the next scheduled traveling time.

Then, in step S110, the ECU 20 multiplies the product of the air conditioning operation probability X (0≤X≤1) and the air conditioning power consumption Pac [W] by a conversion coefficient k1 to calculate an air conditioning electricity consumption rate correction amount Cac [Wh/km]. The coefficient k1 is acquired, for example, by dividing the trip time included in the traveling route information used in step S108 by the trip distance.

Then, in step S112, the ECU 20 calculates a predicted electricity consumption rate Ep. The predicted electricity consumption rate Ep is calculated, for example, by subtracting the air conditioning electricity consumption rate correction amount Cac from the basic value Epb of the predicted electricity consumption rate Ep. That is, the predicted electricity consumption rate Ep is calculated by correcting the basic value Epb with the air conditioning electricity consumption rate correction amount Cac. A calculation method of the basic value Epb is not particularly limited. For example, the basic value Epb may be calculated using the traveling route information including information on a travel load of a next scheduled traveling route. In addition, the predicted electricity consumption rate Ep may be corrected using one or more other correction amounts together with the air conditioning electricity consumption rate correction amount Cac.

Then, in step S114, the ECU 20 calculates a travelable distance L. To be specific, the ECU 20 calculates a remaining battery level (i.e., the current battery level) Wb [Wh] by multiplying the current charging rate SOC [%] of the battery 12 by the battery level of the battery 12 obtained when the battery 12 is fully charged. Next, the ECU 20 calculates a travelable distance L by dividing the remaining battery level Wb by the predicted electricity consumption rate Ep calculated in step S112. Then, the ECU 20 displays the calculated travelable distance L on the display device 26.

Additionally, the air conditioning operation information I including the air conditioning operation result information I1 and the vehicle environment information 12 is not necessarily acquired in the vehicle 10 (i.e., the subject vehicle). That is, the air conditioning operation information I may be collected in, for example, one or more other vehicles instead of or in addition to the vehicle 10 and may be acquired via the external system described above.

As described above, according to the present embodiment, in the calculation process PR1, the basic value Epb of the predicted electricity consumption rate Ep is corrected based on the air conditioning operation information I during the past travel of the vehicle 10. As a result, when the vehicle 10 is not traveling, the predicted electricity consumption rate Ep in the future travel can be calculated appropriately in consideration of the use of the air conditioning device 16.

More specifically, according to the present embodiment, in the learning process PR2, the air conditioning operation probability X during the future travel is learned based on the air conditioning operation result information I1 and the vehicle environment information 12. Then, in the calculation process PR1, the air conditioning electricity consumption rate correction amount Cac is calculated based on the product of the air conditioning operation probability X learned in the learning process PR2 and the air conditioning power consumption Pac. Then, the basic value Epb of the predicted electricity consumption rate Ep is corrected by the air conditioning electricity consumption rate correction amount Cac. Therefore, the predicted electricity consumption rate Ep can be appropriately corrected in consideration of the electricity consumption rate Eac of the air conditioning device 16.

Further, in the learning process PR2, based on the air conditioning operation result information I1 and the vehicle environment information 12, the learning of the air conditioning operation probability model, in which the plurality of parameters included in the vehicle environment information 12 are input and the air conditioning operation probability X is output, is performed. Also, the air conditioning operation probability X used for calculating the air conditioning electricity consumption rate correction amount Cac is calculated from the air conditioning operation probability model and the predicted values of the plurality of parameters at the next scheduled traveling time corresponding to an example of the future travel. Therefore, when the vehicle 10 is not traveling, the predicted electricity consumption rate Ep in the next travel can be appropriately calculated using the learned air conditioning operation probability model.

According to the present embodiment, the travelable distance L is calculated from the predicted electricity consumption rate Ep calculated as described above and the remaining battery level Wb of the battery 12. The calculated travelable distance L is displayed on the display device 26. This makes it possible to display the travelable distance L appropriately calculated based on the predicted electricity consumption rate Ep.

### 3. Another Example of Correction Method for Predicted Electricity Consumption Rate Ep

According to the above-described correction method (see step S110), the air conditioning electricity consumption rate correction amount Cac for correcting the predicted electricity consumption rate Ep is determined to be a value according to the air conditioning operation probability X calculated as a value within the range of 0 to 1, inclusive. Instead of this kind of example, the air conditioning operation probability X used for calculating the air conditioning electricity consumption rate correction amount Cac may be determined as follows.

That is, it may be determined whether or not the air conditioning operation probability X calculated in the processing of step S108 is equal to or greater than a designated threshold value TH (for example, 0.5). Then, when the calculated air conditioning operation probability X is equal to or greater than the threshold value TH, 1 may be used as the air conditioning operation probability X by which the air conditioning power consumption Pac is multiplied in the calculation of the air conditioning electricity consumption rate correction amount Cac. Further, when the calculated air conditioning operation probability X is less than the threshold value TH, 0 may be used as the air conditioning operation probability X by which the air conditioning power consumption Pac is multiplied.

According to the correction method described above, whether or not the air conditioning device 16 will be used in the future travel is determined (predicted) on the basis of the air conditioning operation probability X. Then, when it is determined that the air conditioning device 16 is used, the basic value Epb of the predicted electricity consumption rate Ep is corrected by the air conditioning electricity consumption rate correction amount Cac. On the other hand, when it is determined that the air conditioning device 16 is not used, the correction of the basic value Epb by the air conditioning electricity consumption rate correction amount Cac is not performed.

1. A control device for controlling a vehicle including an electric motor driven by electric power from a battery and an air conditioning device operated by the electric power from the battery, the control device comprising
a processor configured to execute a calculation process of calculating a predicted electricity consumption rate of the vehicle in future travel, when the vehicle is not traveling, wherein
in the calculation process, the processor is configured to correct a basic value of the predicted electricity consumption rate based on past air conditioning operation information of at least one of the vehicle and one or more other vehicles.

2. The control device according to claim 1, wherein
the air conditioning operation information includes air conditioning operation result information and vehicle environment information,
the processor is configured to execute a learning process of learning an air conditioning operation probability based on the air conditioning operation result information and the vehicle environment information, the air conditioning operation probability being a probability that air conditioning operation will be performed during the future travel, and
in the calculation process, the processor is configured to:
calculate an air conditioning electricity consumption rate correction amount based on a product of the air conditioning operation probability learned in the learning process and an air conditioning power consumption, the air conditioning electricity consumption rate correction amount being a correction amount related to electricity consumption rate of the air conditioning device; and
correct the basic value with the air conditioning electricity consumption rate correction amount.

3. The control device according to claim 2, wherein
in the learning process, the processor is configured to learn an air conditioning operation probability model, in which a plurality of parameters included in the vehicle environment information are input and the air conditioning operation probability is output, based on the air conditioning operation result information and the vehicle environment information, and
the air conditioning operation probability used for calculation of the air conditioning electricity consumption rate correction amount is calculated from the air conditioning operation probability model and predicted values of the plurality of parameters at a scheduled time of a next travel corresponding to the future travel.

4. The control device according to claim 1, wherein
the processor is configured to:
calculate a travelable distance of the vehicle from the predicted electricity consumption rate calculated in the calculation process and a remaining level of the battery, the travelable distance being a distance that the vehicle can travel with the remaining level; and
display the calculated travelable distance on a display device.
